(19) United States
(12) Patent Application Publication
(10) Pub. No.: US 2013/0311804 A1
(43) Pub. Date: Nov. 21, 2013

(54) MASTER SLAVE QPI PROTOCOL FOR COORDINATED IDLE POWER MANAGEMENT IN GLUELESS AND CLUSTERED SYSTEMS

(71) Applicants: Vivek Garg, Folsom, CA (US); Krishnakanth KK Sistla, Beaverton, OR (US); Robert Rob Blankenship, Tacoma, WA (US); Dean Mulla, Saratoga, CA (US); Daniel Dan Borkowski, Lunenburg, MA (US); Shaun Conrad, Cornelius, OR (US); Ganapati Gans Srinivasa, Portland, OR (US)

(72) Inventors: Vivek Garg, Folsom, CA (US); Krishnakanth KK Sistla, Beaverton, OR (US); Robert Rob Blankenship, Tacoma, WA (US); Dean Mulla, Saratoga, CA (US); Daniel Dan Borkowski, Lunenburg, MA (US); Shaun Conrad, Cornelius, OR (US); Ganapati Gans Srinivasa, Portland, OR (US)

(21) Appl. No.: 13/994,294

(22) PCT Filed: Apr. 30, 2012
(86) PCT No.: PCT/US12/35827

§ 371 Date: Jun. 14, 2013

(51) Int. Cl. G06F 1/32

(52) U.S. Cl. CPC G06F 1/3203
USPC 713/320

(57) ABSTRACT

Methods, apparatus, and systems for implementing coordinated idle power management in glueless and clustered systems. Components for facilitating coordination of package idle power state between sockets in a glueless system such as a server platform include a master entity in one socket (i.e., processor) and a slave entity in each socket participating in the power management coordination. Each slave collects idle status inputs from various sources and when the socket cores are sufficiently idle, it makes a request to the master to enter a deeper idle power state. The master coordinates global power management operations in response to the slave requests, including broadcasting a command with a target latency to all of the slaves to allow the processors to enter reduced power (i.e., idle) states in a coordinated manner. Communications between the entities is facilitated using messages transported over existing interconnects and corresponding protocols, enabling the benefits associated with the disclosed embodiments to be implemented using existing designs.

### FIELD OF THE INVENTION

The field of invention relates generally to computer systems and, more specifically but not exclusively relates to coordinated idle power management in glueless and clustered systems.

### BACKGROUND INFORMATION

Ever since the introduction of the microprocessor, computer systems have been getting faster and faster. In approximate accordance with Moore's law (based on Intel® Corporation co-founder Gordon Moore's 1965 publication predicting the number of transistors on integrated circuits to double every two years), the speed increase has shot upward at a fairly even rate for nearly three decades. At the same time, the size of both memory and non-volatile storage has also steadily increased, such that many of today's personal computers are more powerful than supercomputers from just 10-15 years ago. In addition, the speed of network communications has likewise seen astronomical increases.

The combination of increases in processor speeds, memory and storage sizes, and network communications has facilitated the recent propagation of cloud-based services. In particular, cloud-based services are typically facilitated by a large number of interconnected high-speed servers, with host facilities commonly referred to as server “farms” or data centers. These server farms and data centers typically comprise a large-to-massive array of rack and/or blade servers housed in specially-designed facilities. Of significant importance are power consumption and cooling considerations. Faster processors generally consume more power, and when such processors are closely packed in high-density server deployments overall performance is often limited due to cooling limitations. Moreover, power consumptions at the deployments are often extremely high so high that server farms and data centers are sometimes located at low electrical cost locations, such as the massive 470,000 square feet server farm Microsoft has deployed in an area of central Washington having one of the lowest electrical power rates in the United States.

Many of today's rack and blade server architectures employ multiple processors. These architectures provide higher performance densities, along with other benefits, such as built-in redundancy and scalability. Since server farm and data center workloads are highly variable, it is advantageous to only keep as many servers active as necessary, thereby reducing power consumption. However, it is not as easy as simply turning servers on and off on demand. One way to reduce power consumption when using servers employing multiple processors is to put one or more of the processors into a very-low power idle state. Under typical virtual machine and/or operating system considerations, putting a processor in a multi-processor server into an idle state requires coordination between the processors so that applications running on the servers remain operational. This becomes even more involved when attempting to put an entire server into a deep idle (aka ‘sleep’) state. Under existing techniques, the processor idle coordination operations involve a significant level of inter-processor communication.

### BRIEF DESCRIPTION OF THE DRAWINGS

The foregoing aspects and many of the attendant advantages of this invention will become more readily appreciated as the same becomes better understood by reference to the following detailed description, when taken in conjunction with the accompanying drawings, wherein like reference numerals refer to like parts throughout the various views unless otherwise specified:

FIG. 1 shows the layers of the QPI protocol stack;

FIG. 2 is a schematic diagram illustrating the structure of a QPI link;

FIGS. 3a-d illustrate various exemplary platform configurations under which embodiments of the invention may be implemented;

FIG. 4 is a schematic block diagram illustrating a high-level architecture of a processor that may be employed in embodiments disclosed herein;

FIGS. 5a and 5b show details of a power management message structure, according to one embodiment;

FIGS. 6a and 6b collectively comprise a message flow diagram depicting message flows and corresponding operations for effecting negotiation of entry into a reduced power state for a platform, according to one embodiment;

FIG. 7 show a platform architecture including selected platform components used in conjunction with the message flow diagram of FIGS. 6a and 6b;

FIG. 8 shows an exemplary system architecture including platforms connected to multiple nodes controllers, wherein power management facilities in accordance with aspects of the embodiments herein may be extended to effect power management across the system;

FIGS. 9a and 9b collectively comprise a message flow diagram depicting message flows and corresponding operations for effecting negotiation of entry into a reduced power state for a system including multiple node controllers, according to one embodiment;

FIG. 10 is a system diagram illustrating a system including multiple node controllers and multiple platforms connected to each node controller, wherein components in the system are configured to implement coordinated power management for the platforms in the system.

### DETAILED DESCRIPTION

Embodiments of methods, apparatus, and systems for implementing coordinated idle power management in glueless and clustered systems are described herein, in the following description, numerous specific details are set forth (such as implementations using the QPI protocol) to provide a thorough understanding of embodiments of the invention. One skilled in the relevant art will recognize, however, that the invention can be practiced without one or more of the specific details, or with other methods, components, materials, etc. In other instances, well-known structures, materials, or operations are not shown or described in detail to avoid obscuring aspects of the invention.

Reference throughout this specification to “one embodiment” or “an embodiment” means that a particular feature, structure, or characteristic described in connection with the embodiment is included in at least one embodiment of the present invention. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

For clarity, individual components in the Figures herein may also be referred to by their labels in the Figures, rather than by a particular reference number. Additionally, reference numbers referring to a particular type of component (as opposed to a particular component) may be shown with a reference number followed by “(TYP)” meaning “typical.” It will be understood that the configuration of these components will be typical of similar components that may exist but are not shown in the drawing Figures for simplicity and clarity.

As a general note, references to the term “sockets” are made frequently herein. A socket (also commonly referred to as a “CPU socket” or “processor socket”) generally represents an electromechanical interface component between a CPU (also referred to herein as a processor) and a processor board typically comprising a type of printed circuit hoard, wherein pins or pads on the CPU are mated to corresponding components (e.g., pin receptacles or pads) on the CPU socket. The processor board may typically be referred to as a motherboard (for personal computers and servers) or a main board, or a blade or card (for blade servers and cards rack configurations). For simplicity and convenience, the term “main board” will generally be used herein, with the understanding that this terminology applies to any type of board on which CPU sockets may be installed.

Also, references will be made to sockets that illustrate internal components of CPU's installed in those sockets. Since the CPU's are configured to be installed in corresponding sockets (and thus would be covering the sockets), reference to a socket that shows selected components of a CPU shall be viewed as if a CPU is installed in the socket being referenced. Accordingly, the use of the term “socket” in the text and drawings herein may apply similarly to a CPU or processor, such that “socket,” “CPU,” and “processor” may apply to the same component.

Under conventional approaches, it is necessary that each processor in a multi-socket system be aware of the power state of each other socket, and to changes in the powers states of the sockets. Under one current approach, this is facilitated by the use of peer-to-peer communications between the sockets. However, this approach is communication intensive, since each socket must inform every other socket of the power state it is willing to go to. At any given time, no single socket is aware of what the other socket power states are. This existing protocol is subject to numerous race conditions which make the protocol validation a challenge.

In accordance with aspects of the embodiments described herein, a novel technique for coordinating package idle power state between sockets in a multi-socket system is disclosed. The technique employs entities in the system to coordinate the package power state between a first socket (aka master) and one or more slave sockets comprising the remaining sockets in the system. Communications between the entities is facilitated using messages transported over existing interconnects and corresponding protocols, enabling the benefits associated with the disclosed embodiments to be implemented using existing designs.

In further detail, components for facilitating coordination of package idle power state between sockets include a single master entity in the system and a slave entity in each socket which is to participate in the power management coordination. Each slave collects idle status from various sources and when the socket cores are sufficiently idle, it makes a request to the master to enter a deeper idle power state. The master is responsible for coordinating all slave requests, and communicating with the PCH (Platform Component Hub). Once coordination is complete, the master broadcasts a target state to all of the slaves. Upon receiving the target state, the slaves work independently to take power saving actions to enter idle power state. They use an idle detect mechanism for the uncore to determine when there is no traffic in the uncore, and once idle, triggers an entry into deep sleep state.

In one embodiment, messaging between master and slave agents is facilitated using the Intel QuickPath Interconnect® (QPI) protocol implemented over corresponding QPI point-to-point serial interconnects between sockets. QuickPath Interconnect® (QPI). QPI was initially implemented as a point-to-point processor interconnect replacing the Front Side Bus on platforms using high-performance processors, such as Intel® Xeon®, and Itanium® processors. More recently, QPI has been extended to support socket-to-socket interconnect links, in order to gain a better understanding of how QPI is implemented, the following brief overview is provided.

Overview of QuickPath Interconnect

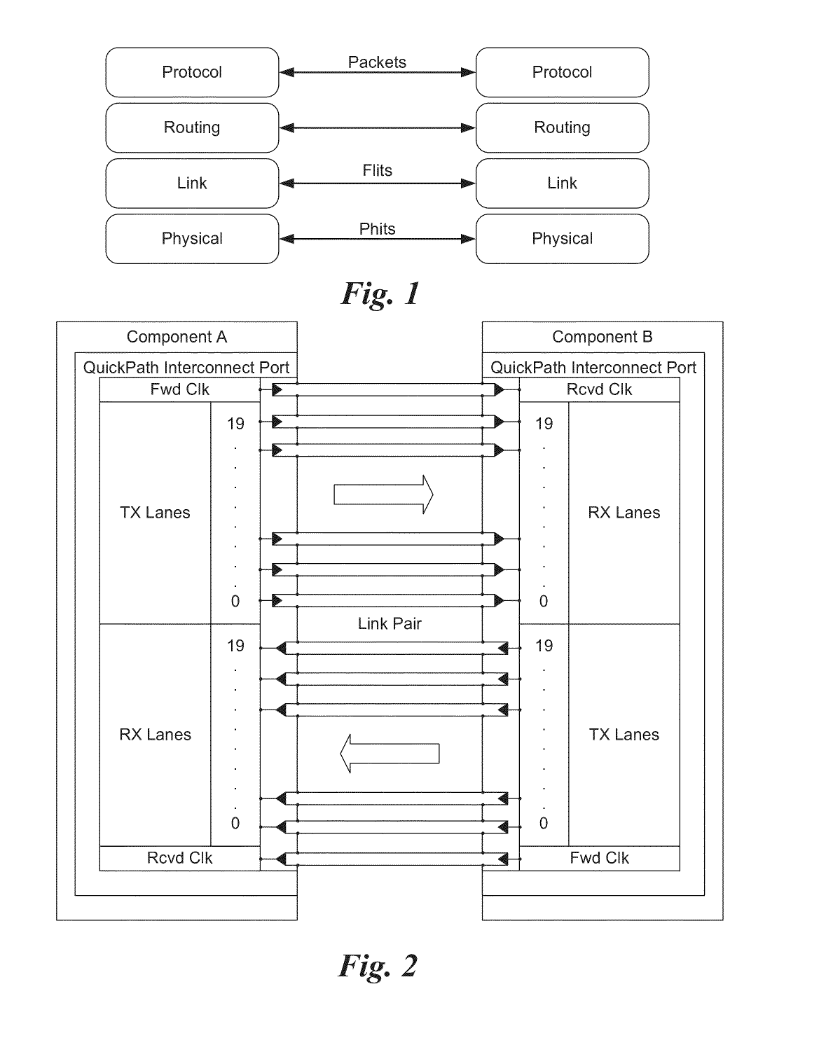

QPI transactions are facilitated via packetized messages transported over a multi-layer protocol. As shown in FIG. 1, the layers include a Physical layer, a Link layer, a Transport layer, and a Protocol layer. At the Physical layer, data is exchanged in 20-bit phits (Physical Units). At the link layer phits are aggregated into 80-bit flits (flow control units). At the Protocol layer, messages are transferred between agents using a packet-based transport.

The Physical layer defines the physical structure of the interconnect and is responsible for dealing with details of operation of the signals on a particular link between two agents. This layer manages data transfer on the signal wires, including electrical levels, timing aspects, and logical issues involved in sending and receiving each bit of information across the parallel lanes. As shown in FIG. 2, the physical connectivity of each interconnect link is made up of twenty differential signal pairs plus a differential forwarded clock. Each port supports a link pair consisting of two uni-directional links to complete the connection between two components. This supports traffic in both directions simultaneously.

Components with QPI ports communicate using a pair of uni-directional point-to-point links, defined as a link pair, as shown in FIG. 2. Each port comprises a Transmit (Tx) link interface and a Receive (Rx) link interface. For the illustrated example, Component A has a Tx port that is connected to Component B Rx port. One uni-directional link transmits from Component A to Component B, and the other link transmits from Component B to Component A. The “transmit” link and “receive” link is defined with respect to a specific QPI agent. The Component A transmit link transmits data from Component A Tx port to Component B Rx port. This same Component A transmit link is the Port B receive link.

The second layer up the protocol stack is the Link layer, which is responsible for reliable data transmission and flow control. The Link layer also provides virtualization of the physical channel into multiple virtual channels and message classes. After the Physical layer initialization and training is completed, its logical sub-block works under the direction of the link layer, which is responsible for flow control. From this link operational point onwards, the logical sub-block communicates with the Link layer at it flit granularity (80 bits) and transfers flits across the link at a phit granularity (20 bits). A flit is composed of integral number of phits, where a phit is defined as the number of bits transmitted in one unit interval (UI). For instance, a full-width QPI link transmits and receives a complete flit using four phits. Each flit includes 72 bits of payload and 8 bits of CRC.

The Routing layer is responsible for ensuring that messages are sent to their proper destinations, and provides the framework for directing packets through the interconnect fabric. If a message handed up from the Link layer is destined for an agent in another device, the Routing layer forwards it to the proper link to send it on. All messages destined for agents on the local device are passed up to the protocol layer.

The Protocol layer serves multiple functions. It manages cache coherence for the interface using a write-back protocol. It also has a set of rules for managing non-coherent messaging. Messages are transferred between agents at the Protocol level using packets. The Protocol layer manages delivery of messages across multiple links, involving multiple agents in multiple devices.

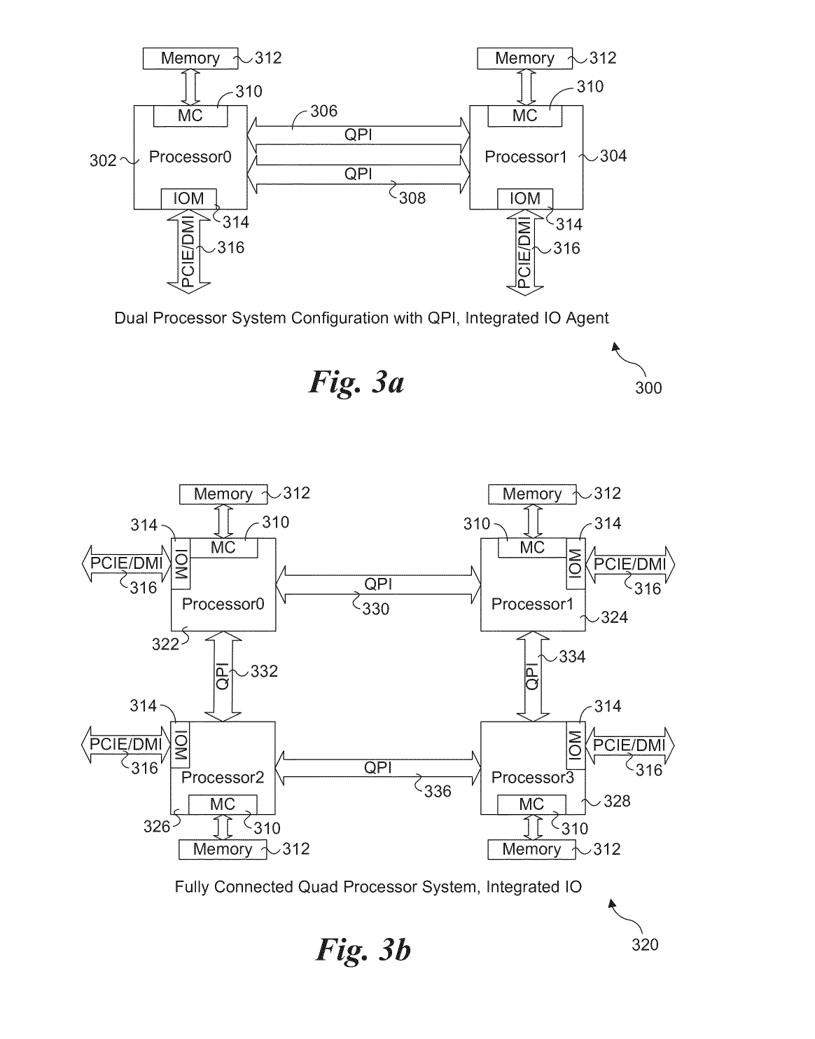

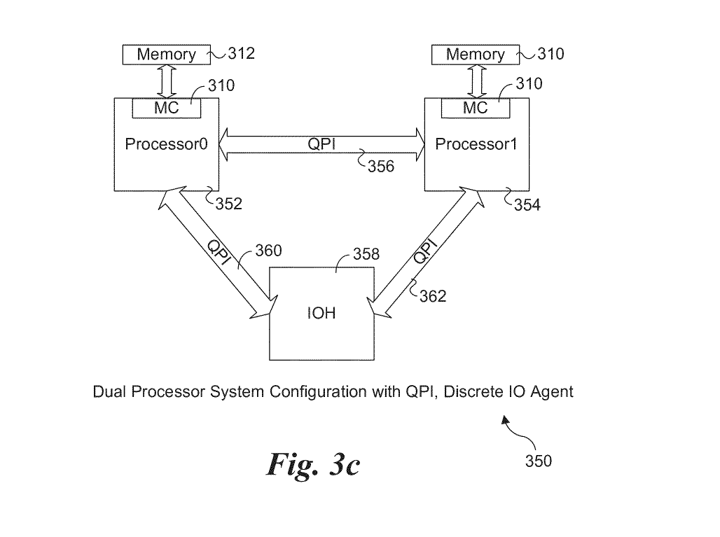

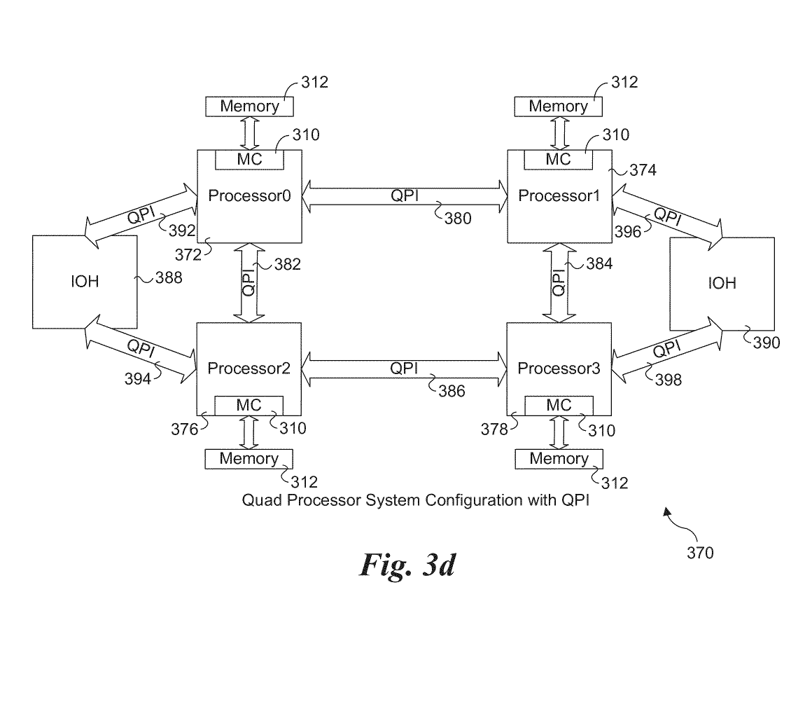

FIGS. 3a-3d illustrate exemplary platform (i.e., computer system, server, etc.) configurations for which embodiments of the invention may be implemented. In addition to the platform configurations shown, there are other platform configurations that may be implementing using similar approaches described herein. Components depicted with the same reference numbers perform similar functions in FIGS. 3a-3d.

FIG. 3a depicts a block diagram of a platform configuration 300 comprising dual processor system employing QPI links and integrated 10 agents. In further detail, processors 302 and 304 are connected via QPI links 306 and 308. Each of processors 302 and 304 further include a memory controller (MC) 310 configured to operate as an interface and provide access to memory 312, and an input/output module (IOM) 314 configured to support a PCI Express (PCIE) interface and/or a Direct Memory Interface (DMI) to corresponding PCI and/or DIM links, which are collectively depicted as a PCIE/DMI link 316.

FIG. 3b shows a platform configuration 320 comprising a fully-connected quad processor system with integrated IO including four processors 322, 324, 326, and 328 connected in communication via four QPI links 330, 332, 334 and 336. As before, each processor includes an MC 310 and IOM 314 depicted as being respectively coupled to memory 312 and a PCIE/DMI link 316.

FIG. 3c shows a platform configuration 350 comprising a dual processor system with QPI and discrete 10 agents. The system includes a pair of processors 352 and 354 coupled to on another via a QPI link 356 and coupled to an IO hub (IOH) 358 via QPI links 360 and 362. Each of processors 352 and 354 also include an MC 310 coupled to memory 312.

FIG. 3d depicts a platform configuration 370 comprising a quad processor system configuration with QPI and discreet 10 agents. System configuration 370 includes four processors 372, 374, 376, and 378 connected in communication via six QPI links 380, 382, 384, and 386. The system further includes IOHs 388 and 390 and QPI links 392, 394, 396, and 398. Each of processors 372, 374, 376, and 378 also include an MC 310 coupled to memory 312.

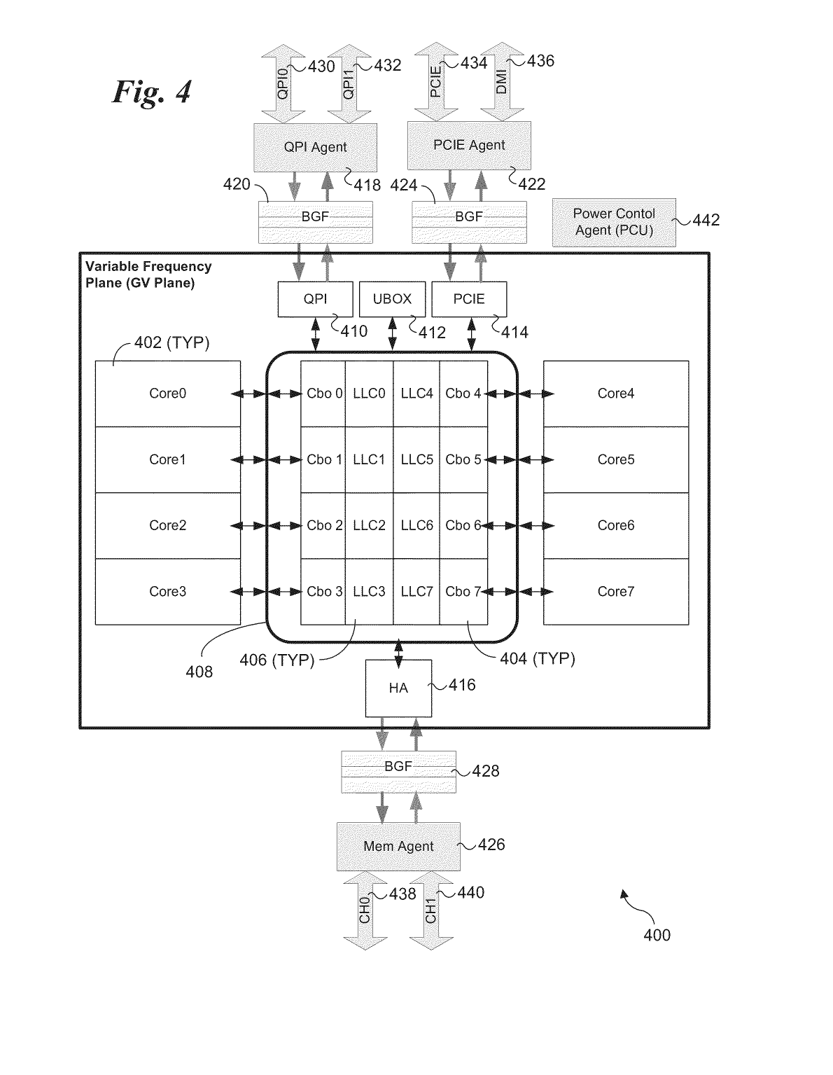

FIG. 4 shows an exemplary processor architecture 400 that may be used for the processors included in the embodiments described herein. The processor architecture is simplified and only depicts selected components for brevity and clarity. Processor architecture 400 depicts an 8-core processor including processor cores 402 (labeled Core0-Core7), which are coupled to respective caching boxes 404 (labeled Cbo 0-7, also referred to as CBOXes) and last level caches (LLCs) 406 (labeled LLC0-LLC7). The processor cores, Cbo's and LLC's are connected to nodes (not shown) on a ring interconnect 408. Also connected to ring interconnect 408 via corresponding nodes (not shown) are a QPI block 410, a UBOX (Utility Box) 412, a PCIE block 414, and a Home Agent (HA) 416.

QPI block 410 includes a QPI interface that is coupled to a QPI agent 418 via a buffer 420. PCIE block 414 is coupled to a PCIE agent 422 via a buffer 424. Meanwhile, HA 416 is coupled to a memory agent 426 via a buffer 428. Each of the QPI, PCIE, and memory agents are depicted as coupled to corresponding communication links, including QPI agent 418 couple to QPI links 430 and 432, PCIE agent 422 coupled to PCIE links 434 and 436, and memory agent 426 coupled to memory channels 438 and 440.

In general, the components of processor architecture 400 are interconnected via various types of interconnects, which are depicted as double-headed arrows for convenience. As discussed above, in one embodiment, processor architecture 400 employs a ring interconnect 408. Optionally, the processor cores and related components and agents may be connected via an interconnect fabric (e.g., a 2D mesh interconnect). The interconnects may comprises point-to-point interconnects (e.g., QPI, PCIE, Open Core Protocol (OCP) etc.), as well as buses and other types of interconnect structures.

Processor architecture 400 further includes a Power Control Unit (PCU) 442. The PCU's of the various processors in the foregoing architectures are configured to facilitate power control aspects for each processor, such as putting a processor and/or its components into various reduced power states, and communicating power state information and latency information to other processors over applicable communication links.

Intel® processors typically support four power management states for their microprocessor, CPU package, and overall system. TABLE 1 provides the various power management state names along with a brief description.

TABLE 1

| State | Description |
|---|---|
| P-State | Microprocessor Performance |
| T-State | Microprocessor Throttle |
| C-State | Microprocessor and Package |
| S-State | System Sleep States |

Microprocessor performance states (P-States) are a pre-defined set of frequency and voltage combinations at which the microprocessor can operate when the CPU is active. The microprocessor utilizes dynamic frequency scaling (DFS) and dynamic voltage scaling (DVS) to implement the various P-States supported by a microprocessor. DES and DVS are techniques that dynamically changes the operating frequency and operating voltage of the microprocessor core based on current operating conditions. The current P-State of the microprocessor is determined by the operating system. The time required to change from one P-State to another is relatively short. The operating system takes this time into account when it dynamically changes P-States. The OS manages the tradeoff between power consumption by the microprocessor and the performance of the microprocessor.

A C-State is defined as an idle state. When nothing useful is being performed, various parts of the microprocessor can be powered down to save energy. There are three classifications of C-States: thread (logical) C-States, microprocessor core C-States, and microprocessor package (Pkg) C-States. Some aspects of all three categories of C-States are similar, since they all represent some form of an idle state of a processor thread, processor core, or processor package. However, the C-States are also different in substantial ways.

A thread (logical) C-State represents the operating system's view of the microprocessor's current C-States, at the thread level. When an application asks for a processor's core C-State, the application receives the C-State of a “logical core.” A logical core is what an application's individual thread perceives to be a core, since the thread perceives to have full ownership of a particular core. As an example, for a CPU employing two logical cores per physical core (such as an Intel® CPU supporting Hyperthreading®), logical Core 0 (thread 0 executing on Core 0) can be in a specific idle state while logical Core 1 (thread 1 on Core 0) can be in another idle state. The operating system can request any C-State for a given thread.

A core C-State is a hardware-specific C-State. Under one embodiment, any core of the multi-core CPU residing on CPU package can be in a specific C-State. Therefore, all cores are not required to be in the same C-State. Core C-States are mutually exclusive per-core idle states.

A package C-state is an idle state that applies to all cores in a CPU package. The package C-State of the CPU is related to the individual core C-States. The CPU can only enter a low-power package C-State when all cores are ready to enter that same core C-State. Therefore, when all cores are ready to enter the same lower power core C-State, then the package can safely transition into the equivalent lower power package C-State.

In one embodiment, there are four C-States (idle states), including idle state C0, idle state C1, idle state C3, and idle state C0. The higher the C-State, the higher the level of idle and the greater the power savings, beginning with idle State C0, which corresponds to a normal active operational state for a core. For example, while in idle state C6, the core PLLs (Phase-Lock Loops) are turned off, the core caches are flushed and the core state is saved to the Last Level Cache (LLC). The power gate transistors are activated to reduce power consumption to a particular core to approximately zero Watts. A core in idle state C6 is considered an inactive core. The wakeup time for a core in idle state C6 is the longest. In response to a wakeup event, the core state is restored from the LLC, the core PLLs are re-locked, the power gates must be deactivated, and core clocks are turned back on.

Since C6 is the deepest C-State, the energy cost to transition to and from this state is the highest. Frequent transition in and out of deep C-States can result in a net energy loss. To prevent this, some embodiments include an auto-demote capability that uses intelligent heuristics to determine when idle period savings justify the energy cost of transitioning into a deep C-State and then transition back to C0. If there is not enough justification to transition to C6, the power management logic demotes the OS C-State request to C3.

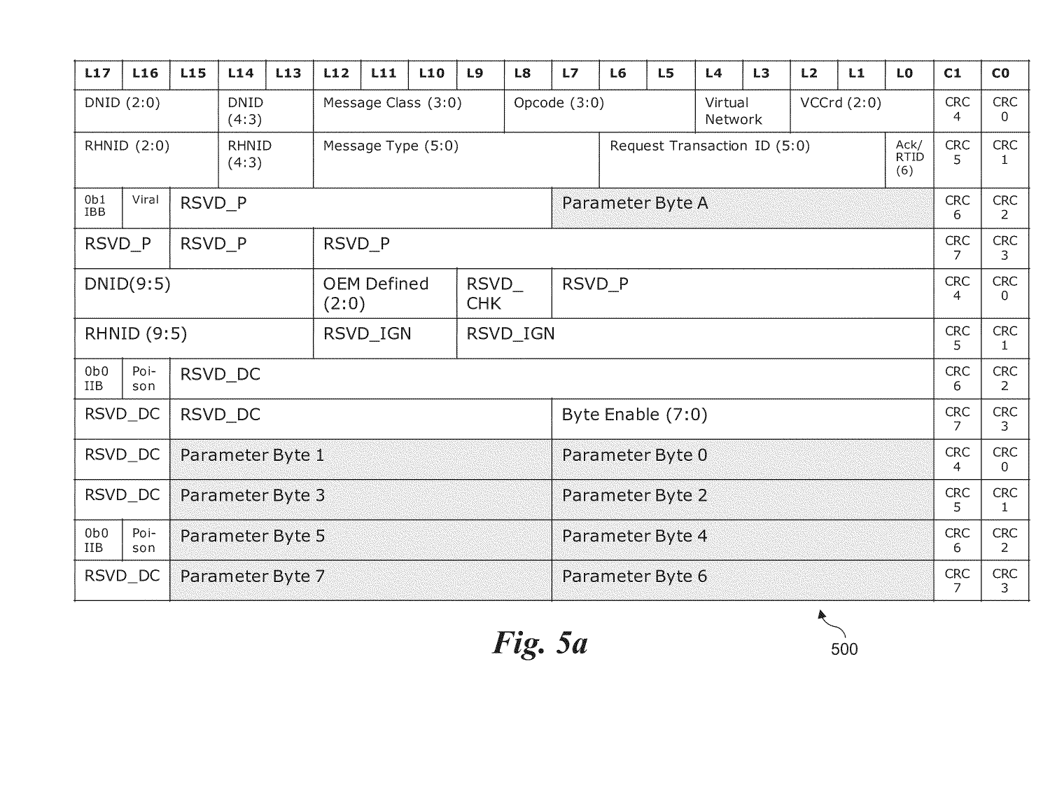

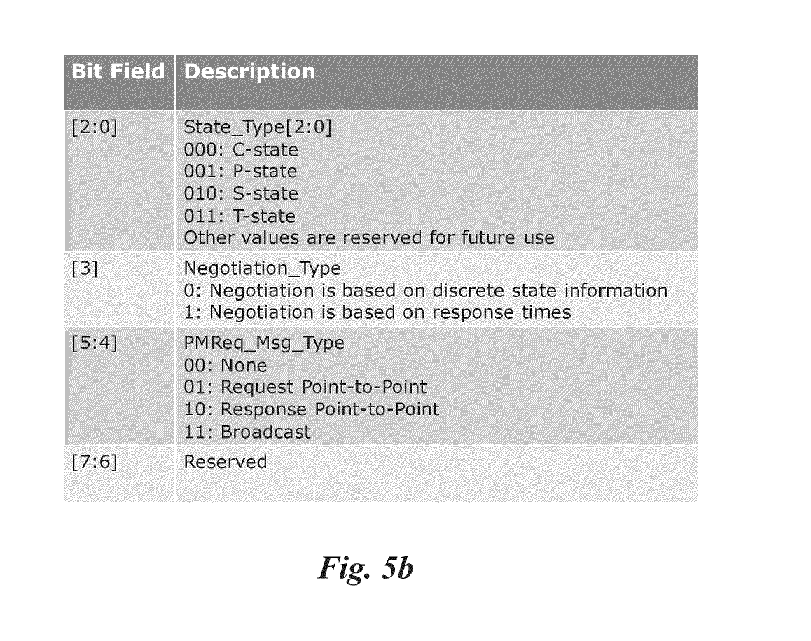

As discussed above, in one embodiment, messaging between Master and Slave entities is facilitated using the Intel QuickPath interconnect® (QPI) protocol implemented over corresponding QPI point-to-point serial interconnects between sockets. In one embodiment, non-coherent QPI messages referred to as PMReq (Power Management Request) messages are used for communicating information relating to power management operations between various system components and between CPU's. FIG. 5a shows a QPI message format 500 corresponding to PMReq message, according to one embodiment. As shown, portions of the message format comprising a Parameter Byte A and Parameter Bytes 0-7 are highlighted, as the values of these parameters (as applicable to correspond PMReq message formats) are used to convey various information corresponding to the PMReq messages. One embodiment of the Parameter Byte A usage is shown in FIG. 5b. As shown, the bits in Parameter Byte A are divided into a State_Type field, a Negotiation_Type bit, and a PMReq_Msg_Type field, with bits [7:6] reserved for potential future use. As used in the message flow diagrams below, ‘Param’ refers to Parameter Byte A, while ParamN refers to Parameter Byte N.

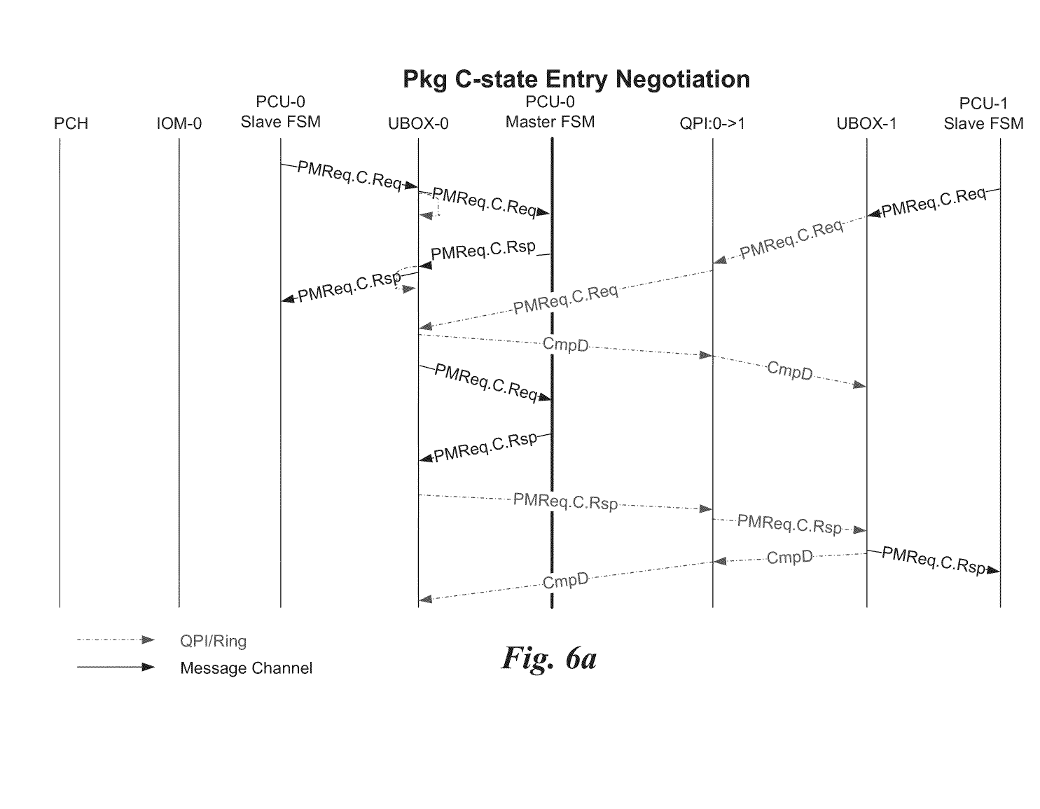

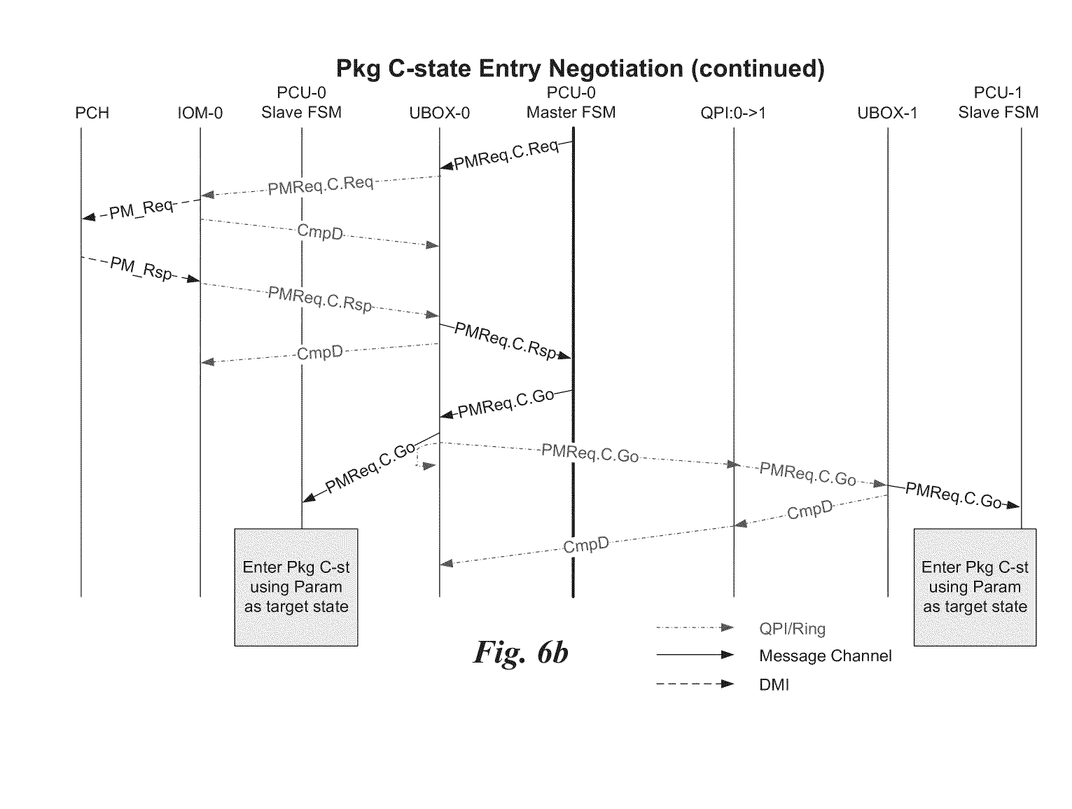

FIGS. 6a and 6b collectively show a message flow diagram depicting messages that are sent between various components in a pair of sockets (i.e., CPU's) to facilitate a Pkg C-state entry negotiation, according to one embodiment. In the message flow diagram, the Y-axis corresponds to time, beginning at the top of the diagram and flowing downward. (It is noted that the time axis is not to scale, but is merely used to depict relative timing of messages.) A legend and corresponding linetypes are used to convey the message delivery mechanism, i.e., over QPI or the Ring interconnect, over a message channel, or using DMI.

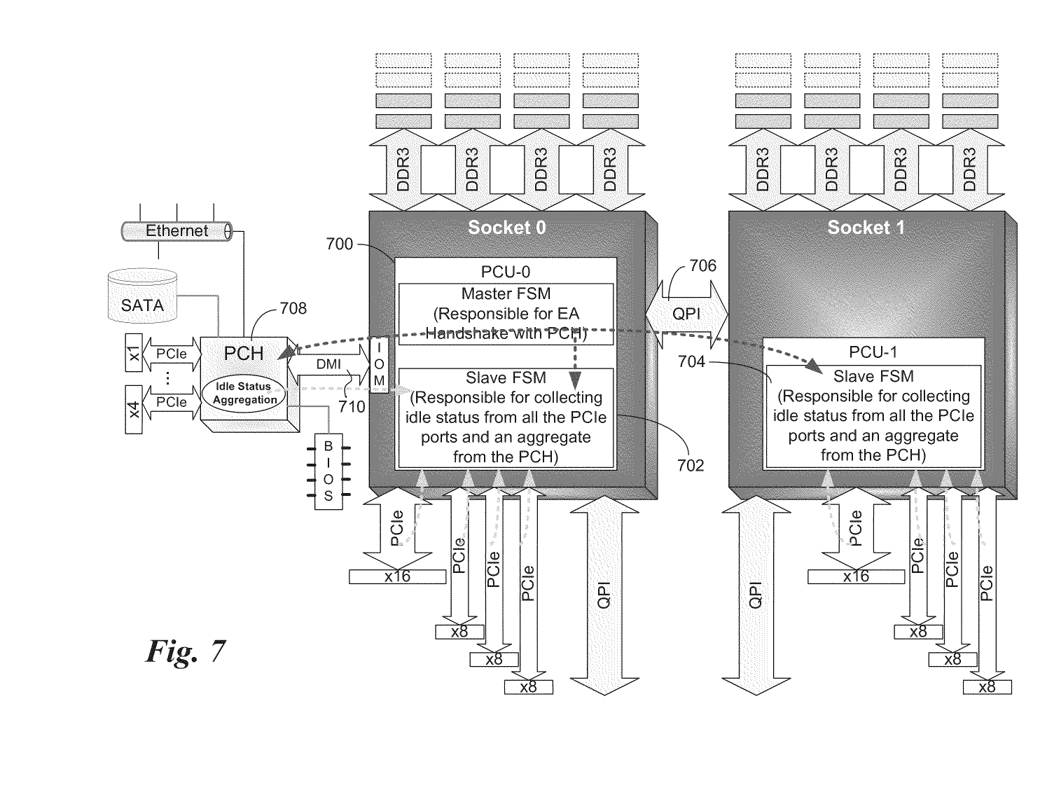

FIG. 7 illustrates an exemplary platform configuration used for implementing the Pkg C-State entry negotiation operations corresponding to the message flow diagram in FIGS. 6a and 6b. As shown, Socket 0 is a Master socket, while Socket 1 is a Slave socket. The Master socket includes a Master FSM (finite state machine) 700 and a Slave FSM 702. Each Slave socket in a platform, as exemplified by Socket 1, includes a Slave FSM, as depicted by a Slave FSM 704. In one embodiment, the Master and/or Slave FSM for a given socket are implemented in the PCU for the socket.

The Master FSM effects platform entry into the Pkg C-state in response to receiving Pkg C-state entry requests (PmReq.C.Req messages, also referred to as PM.Req messages) from the platform sockets. In response to receiving each request, the Master FSM returns PmReq.C.Rsp messages (also referred to as PM.Rsp messages) indicating whether Execution (is) Allowed (EA). The Master FSM waits until it has received a PmReq.C.Req message from all sockets, and then negotiates EA and latency with the PCH. It then informs all sockets of the globally agreed upon response time via PmReq.C.Go messages, thereby initiating entry of each socket into the Pkg C-state originally requested by that socket. For example a socket may request to enter a Pkg C3 state or a Pkg C6 state.

Each Slave FSM collects idle status information from its local devices. It determines, based on local core status, when entry into Pkg C-state for the socket is appropriate. In response to detecting an appropriate condition, the Slave FSM sends PMReq.C.Req messages with desired idle state and EA status to the Master FSM. It then waits for the response (PMReq.C.Res) and Go (PMReq.C.Go) messages. Upon receiving a Go message, the Slave FSM employs the target state passed with the message to determine the applicable Pkg C-state it can enter. It then initiates entry into that Pkg C-state for the socket based on the uncore state.

Various PMReq message include EA status information. This information is used to indicate to the recipient that the sender no longer has any active cores is EA=0, and if sender is asking for EA=1, i.e. a change in status—it wants the cores to become active. The EA status is used to establish when all cores in a platform are idle. In response to detection of this condition, the EA status is communicated to the PCH to let the PCH and downstream devices know that none of the cores are active and the PCH or devices can cache writes to memory locally and not disturb the socket. Additionally, EA transition from 0 to 1 needs to be communicated to the so that the write cache being maintained in the PCI-1 can be flushed to memory before any core is allowed to wake up. Thus, the EA parameter used to maintain coherence between devices and cores.

With reference to FIG. 6a, the Pkg C-state entry negotiation process starts with Slave FSM 702 in the PCU of Socket 0 sending a PMReg.C.Reg message to Master FSM 700 via the UBOX in Socket 0 (UBOX-0). As shown, messages depicted using a solid linetype are transferred over a Message Channel, which comprises a messaging mechanism internal to each socket. Also as depicted, a portion of the message routing may employ a QPI link and/or the Ring interconnect. In response to receiving the PMReg.C.Req message, Master FSM 700 returns a PMReq.C.Rsp response message acknowledging the request; as before, the PMReq.C.Rsp message is transferred via UBOX-0.

During an asynchronous operation that is depicted during an overlapping timeframe to fit within the diagram, Slave FSM 704 sends a similar PMReq.C.Req message to UBOX-0, wherein the message is transferred via the UBOX on Socket 1 (UBOX-1) and via a QPI link 706 between Socket 0 and Socket 1, as shown in FIG. 7. In response to receiving the PMReg.C.Req message from Slave FSM 704, UBOX 0 returns a CmpD completion message (i.e., a message indicating a corresponding operation has been completed) to UBOX-1 via QPI link 706.

Next, UBOX-0 sends a PMReg.C.Reg message to Master FSM 700, which returns a PMReq.C.Rsp message in response. UBOX-0 then sends a PMReq.C.Rsp message to Slave FSM via QPI link 706 and UBOX-1, followed by UBOX-1 returning a CmpD message back to UBOX-0 via QPI link 706. This completes the portion of the message flow diagram of FIG. 6a.

Continuing at the top of FIG. 6b, Master FSM 700 send a PMReg.C.Reg to UBOX-1, which in response forwards the message to the PCH (as depicted by a PCH 708 in FIG. 7) via IOM-0 and a DMI link 710. At IOM-0 the message is converted into a PM_Reg message; the message content in a PM_Req message is similar to a PMReg.C.Reg message, except DMI employs a different message format than QPI (including a different message name). PCH 708 returns a PM_Rsp message, which is converted at IOM-0 into a PMReq.C.Rsp message that is received by UBOX-0. UBOX-0 then sends a PMreq.C.Rsp message to Master FSM 700, and also returns a CmpD message to IOM-0.

Upon to receiving this PMreq.C.Rsp message, Master FSM 700 updates its socket status information and detects that all platform sockets have a current status requesting entry (EA=0) into a Pkg C-state. Thus, a Go condition exists, and Master FSM 700 sends a PMReq.C.Go message to UBOX-0. This message is broadcast by UBOX-0 to the platform Slave FSMs instructing the Slave FSMs to enter an applicable Pkg C-state, using target state information provided in the PMReq.C.Go message; in this example a PMReq.C.Go message is sent to each of Slave FSM 702 and Slave FSM 704, as shown. In response to receiving the PMReq.C.Go messages, each of Socket 0 and Socket 1 enter Pkg C-state using the target state. UBOX-1 also returns a CmpD message to UBOX-0.

During the power state negotiation process, the Slave FSMs collect idle status data from all of the PCIe ports (for each socket), and also receive aggregate idle status from the PCH, as illustrated in FIG. 7. The aggregate idle status data is used to generate the latency target values sent in the PMReq.C.Go messages.

The Pkg C-state negotiation process illustrated in FIGS. 6a, 6b, and 7 corresponds to a two-socket platform configuration. This can be extended to support three or more sockets by sending messages to the applicable components of the additional (Slave) sockets in a similar manner to the messages received by and sent from the Socket 1 (Slave) components. For example, for a Socket ‘2’, a Slave FSM for a PCU-2 would be employed, along with a UBOX-2 and a QPI link between the Master socket and Socket ‘2’. It is further noted that multiple socket-to-socket QPI links may be used to send messages between a Master socket and a Slave socket when the two sockets are not directly connected via a QPI link. For example, in platform configurations such as shown in FIGS. 3b and 3d, if Processor0 is the Master socket and Processor3 is a Slave socket than a traversal of two QPI socket-to-socket links will be employed.

In addition to employing Master and Slave sockets within a platform, similar power management schemes and related message flows may be implemented to support management of socket power states using Node Controller-(NC) based designs, where a NC in a cluster essentially appears as a slave, and works with a Master FSM to extend the idle power flow to an entire system. For example, an NC-based design could be used to power management in a clustered set of servers such as in a rack server or server blades in a blade server. Moreover, this scheme can be extended to multiple clusters, as discussed below.

in accordance with one embodiment of a NC-based design, a local node controller is treated as another PCU Slave, and the NC appears as another socket to the UBOX. The size of the system is abstracted from both the UBOX and the master PCU. For CPU's configured to support a fixed number of sockets, a node hierarchy scheme can be implemented to enable the total number of sockets in the system to exceed the fixed number. The Master PCU maintains a table of the most recent requests from the agents it needs to track. NCs fir each cluster collect the requests from each of the local sockets and send a consolidated request to the master PCU (or to a Master NC, depending on the system structure).

For PMReq.C.Req messages, the master NC consolidates all the requests from the other NCs and issue a single request on their behalf to the master PCU. Similarly, the Slave NC send a unified PMReq.C.Req message to the master PCU (or to a Master NC, if applicable); this message is not sent until all sockets in the local duster are EA=0, and the message includes the minimum latency that can be tolerated by any of the local sockets.

For PMReq.C.Rsp messages, the master NC passes the response messages through to appropriate slave NCs. Each slave NC also sends Cmp and Rsp messages to the Requester from the local sockets. If an Rsp message is not generated by the NC, then any latency updates or EA changes from the local sockets cannot be communicated to the master PCU until the previous request has been Acknowledged.

For PMReq.Go messages, the Master NC broadcasts the PmReq.Go message to all of the Slave NCs. The Slave NCs then broadcast the PmReq.Go messages received from the master NC to all of the sockets in their clusters.

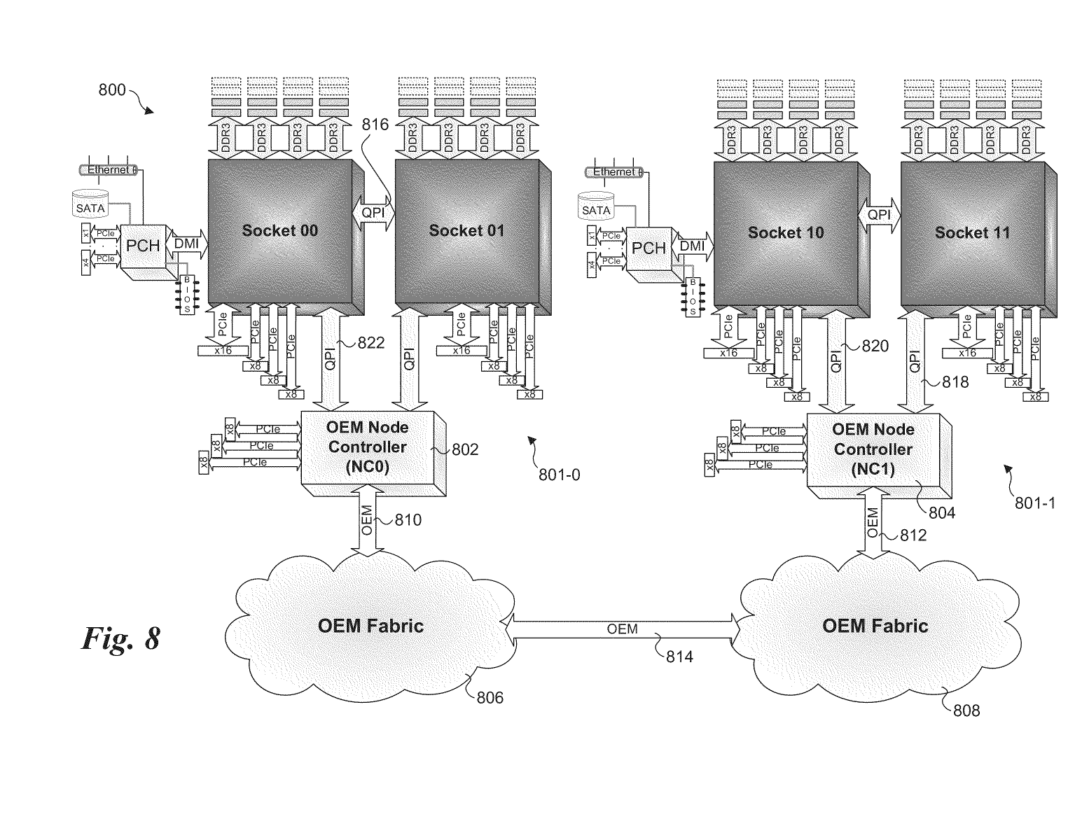

FIG. 8 shows an exemplary node controller-based system 800 topology. The system includes two platforms 801-0 and 801-1 coupled to respective OEM (Original Equipment Manufacturer) node controllers 802 and 804, which in turn are coupled to OEM fabrics 806 and 808 via OEM links 810 and 812. The node controller fabrics 806 and 808 are further connected via an OEM link 814.

In general, various OEMs of system configurations, such as rack server and blade server venders (e.g., Hewlett Packard, IBM, Dell, etc.) may employ their own preference for node controller configuration and fabrics and links implemented for their systems. These components and links may employ standard-based protocols, or may be proprietary. For the purposes herein, the details of the communications over the OEM links and OEM fabrics are abstracted in a generic manner for simplicity and clarity.

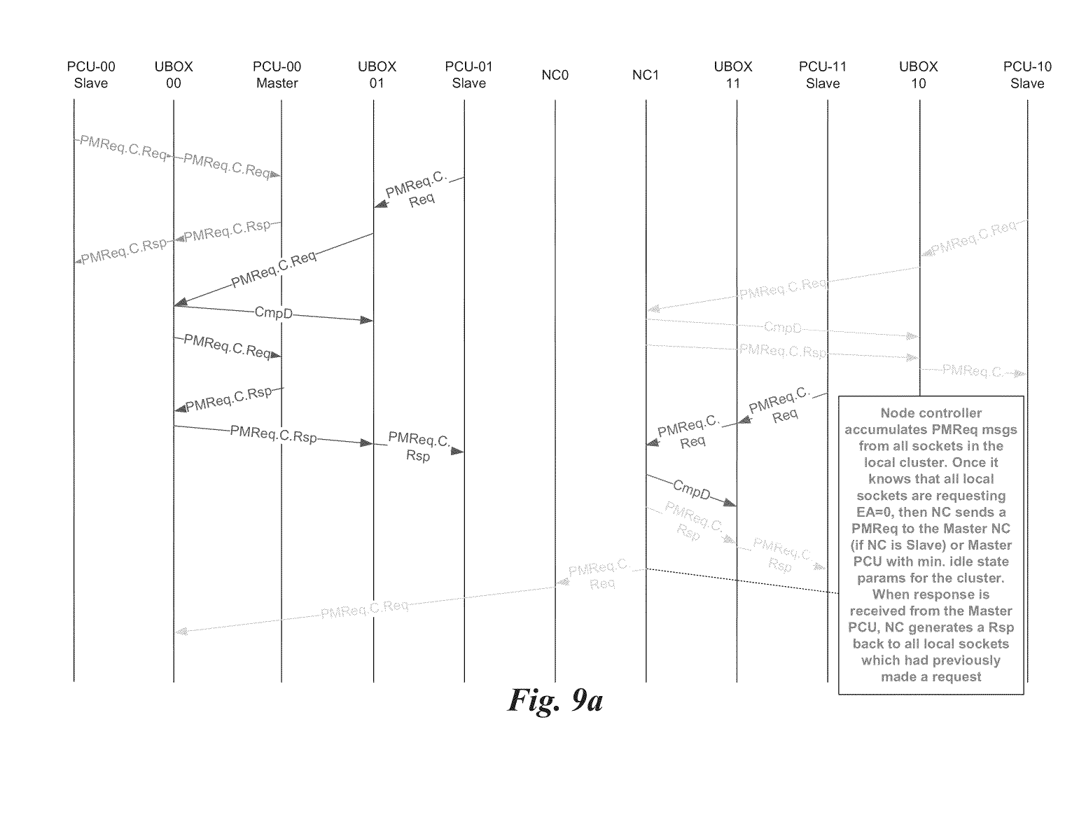

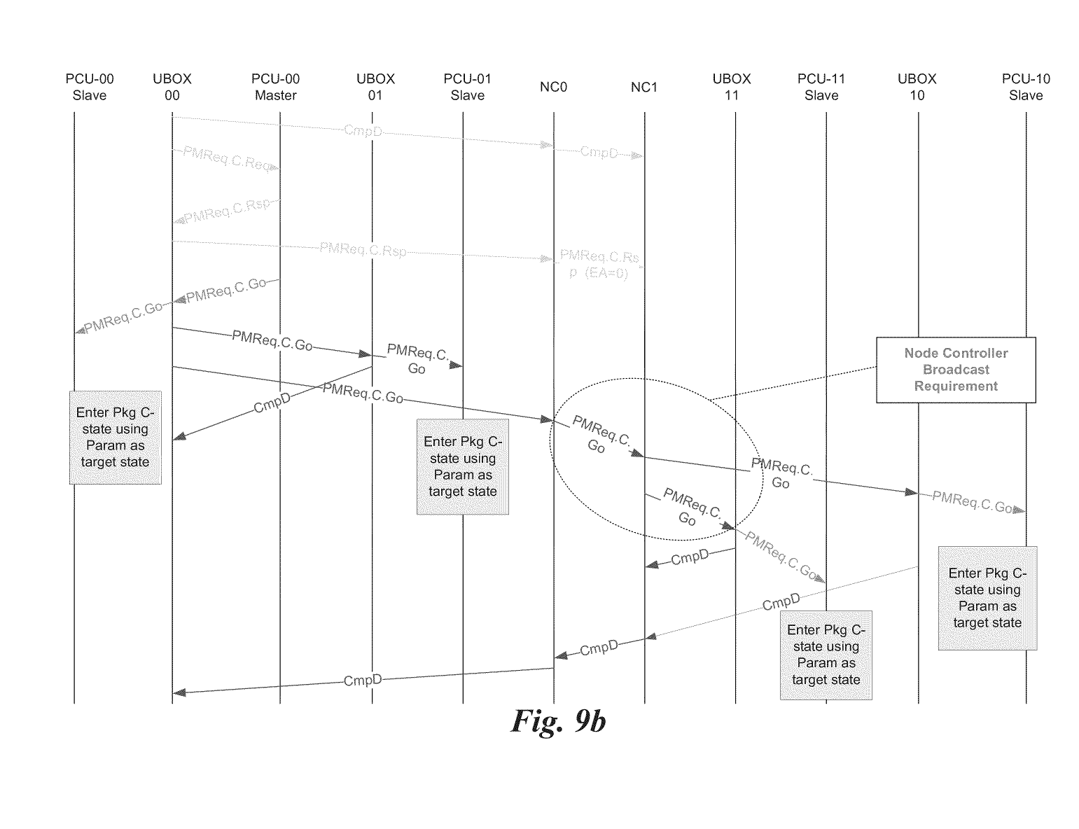

The sockets and related components in the system of FIG. 8 and the message flow diagram of FIGS. 9a and 9b are labeled in the following manner. The two sockets for platform 801-0 are labeled Socket 00 and Socket 01, while the two sockets for platform 801-1 are labeled Socket 10 and Socket 11. Components referenced in the message flow diagram of FIGS. 9a and 9b reference their host socket based on the socket labeling in FIG. 8. For example, UBOX 01 and PCU-01 refer to the UBOX and the PCU on Socket 01, while UBOX 11 and PCU-11 refer to the UBOX and the PCU on Socket 11, etc.

FIGS. 9a and 9h collectively illustrate an exemplary message flow for implementing Pkg C-state entry negotiation for a system employing a pair of node controllers, such as illustrated by system 800. During the negotiation process, a Node controller accumulates PMReq msgs from all sockets in its local cluster. Once the Node controller is aware that all local sockets are requesting to enter a Pkg C-state, the NC sends a PMReq to the master PCU with min idle state Params for the cluster. When the response is received from the master PCU, the NC generates Rsp messages that are sent back to all the local sockets that had previously made request to enter the Pkg C-state.

Beginning at the upper left corner of the diagram of FIG. 9a, a message flow sequence is illustrated relating to an exchange of Req and Rsp messages that is similar to those shown in FIG. 6a for a single platform and discussed above. First, the PCU-00 Slave sends a PMReq.C.Req message to the PCU-00 Master via UBOX 00. In response, the PCU-00 Master returns a PMReq.C.Rsp message to the PCU-00 Slave. During an asynchronous process, the PCU-01 Slave sends a PMReq.C.Req message to UBOX 00 via UBOX 01 and a QPI link 816. UBOX 00 sends a CmpD message to UBOX 01 via QPI link 816, and then sends a PMReq.C.Req message to the PCU-00 Master. The PCU-00 Master then responds with a PMReq.C.Rsp message, followed by UBOX 00 sending a PMReq.C.Rsp message to PCU-01.

The focus is now moved to the right-hand portion of the diagram of FIG. 9a. In this message sequence, a similar Pkg C-state entry negotiation process is initiated. However, since platform 800-1 does not have a Master PCU, the initial Req messages from the PCU Slaves are sent to Node controller 804 (NC1). As illustrated, the PCU-10 Slave sends a PMReq.C.Req message to NC1 via UBOX 10 and a QPI link 818. In response, NC1 returns a CmpD message to UBOX 10, along with a PMReq.C.Rsp message, which is forwarded by UBOX 10 to the PCU-10 Slave. Asynchronously, the PCU-11 Slave initiates a Pkg C-State request by sending a PMReq.C.Req message to NC1 via UBOX 11 and a QPI link 820. In response, NC1 returns a CmpD message to UBOX 11, along with a PMReq.C.Rsp message, which is forwarded by UBOX 11 to the PCU-11 Slave.

The foregoing message flows correspond to messages sent to an NC from a single platform in a local cluster (e.g., as illustrated in system 800). Similar message flows are used for other platforms associated with the local cluster of the NC. During this process, the NC accumulates the PMReq messages from all of the sockets in its cluster. The NC then sends a PMReq to the master PCU with minimum latency parameters for the cluster. This is depicted by NC1 sending a PMReq.C.Req message with the minimum latency parameters to UBOX 00, which then (continuing at the top of FIG. 9b) returns a CmpD message to NC1 and forwards the PMReq.C.Req message to the PCU-00 Master. In response to receiving the PMReq.C.Req message, the PCU-00 Master returns a PMReq.C.Rsp message to UBOX 00, which forwards the message to NC1 via NC0. As shown in system 800, transfer of messages between NC0 (i.e., Node controller 802) and NC1 (Node controller 804) are facilitated via OEM links 810, 812, and 814 and OEM fabrics 806 and 808, while transfer of messages between NC0 and Socket 00 are facilitated by a QPI link 822.

At this point, the PCU-00 Master has received input from NC1 that all of the platforms in its cluster have requested to enter Pkg C-state, and each of the sockets in PCU-00 Master's platform have requested to enter Pkg C-state. Thus, the PCU-00 Master begins to send Go messages to cause the sockets in the local platform and remote cluster to enter Pkg C-state. This begins with the PCU-00 Master sending a PMReq.C.Go message to the PCU-00 Slave via UBOX 00. In response to receiving the PMReq.C.Go message, the PCU-00 Slave causes Socket 00 to enter the Pkg C-State using the value passed in the message for target idle state.

UBOX 00 also forwards PMReq.C.Go messages to each of the PCU-01 Slave (via UBOX 01 and QPI link 816) and to NC1 (via QPI link 822 to NC0, which then forwards the PMReq.C.Go message to NC1). In response to receiving its PMReq.C.Go message, UBOX 01 returns a CmpD message to UBOX 00. Also, in response to receiving its PMReq.C.Go message, PCU-01 Slave causes Socket 01 to enter the Pkg C-state using the passed idle target values.

NCs have the task of facilitating a PCU Master-type proxy role for each of the platforms in its cluster. This comprises broadcasting PMReq.C.Go messages to each socket in the cluster's platforms, which is exemplified in FIG. 9b by broadcasting PMReq.C.Go messages with applicable latency target values to each of the PCU-11 Slave and the PCU-10 Slave, which in response to receiving their PMReq.C.Go messages cause their respective sockets to enter Pkg C-state and return respective CmpD messages to NC1. Upon receiving a CmpD message from each of the sockets in its cluster, the remote NC sends a CmpD message to the UBOX of the PCU Master (e.g., UBOX 00 in FIG. 9b).

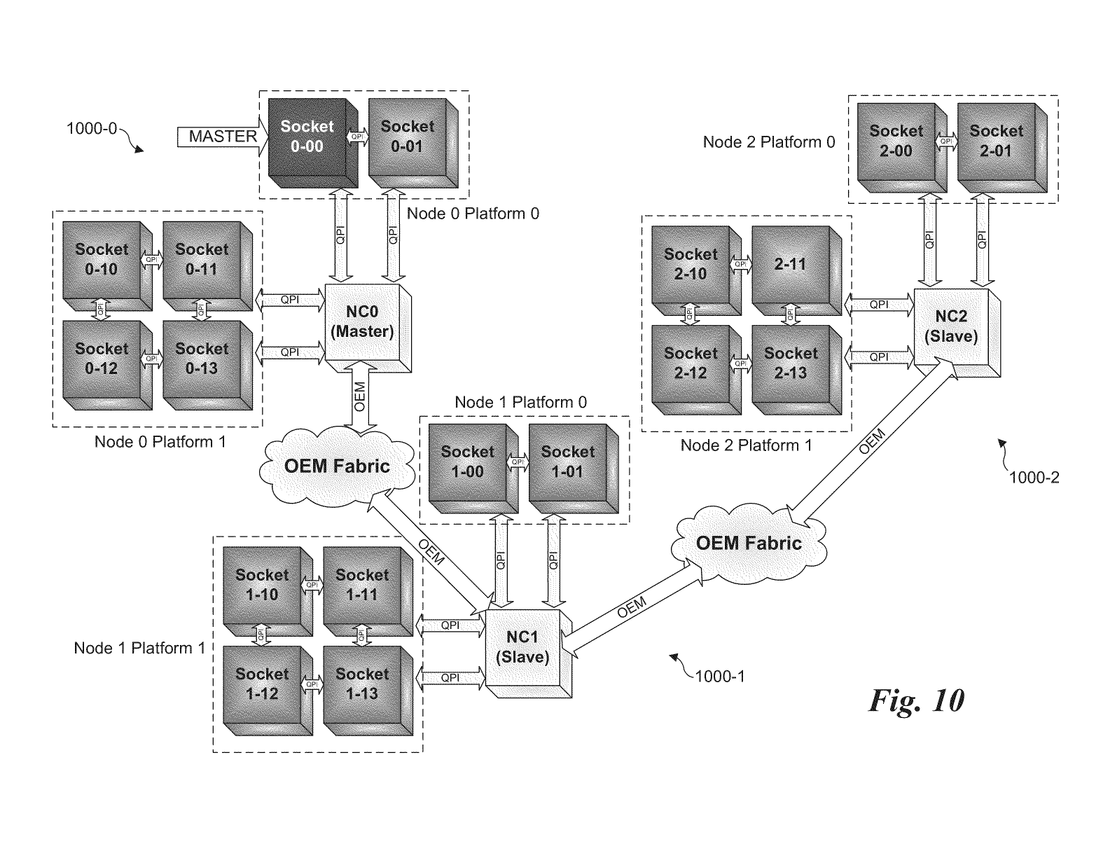

A similar Pgk C-state negotiation and entry scheme to that depicted in FIGS. 8, 9a, and 9b can be extended to a system employing multiple node controllers, such as shown in FIG. 10. This system includes three dusters 1000-0, 1000-1, and 1000-2, each including a pair of platforms coupled to one of node controllers NC0, NC1, and NC2. (It is noted that the exemplary use of two platforms per cluster is for illustrative purposes, as the number of platforms per cluster may be more than two.) The node controllers are interconnected via applicable OEM fabrics and links, in a manner similar to that described above for system 800. Each of the platforms for each cluster is labeled with its NC number and a platform number within the cluster. The Sockets are labeled based on the NC number (first numeral), followed by the platform number and the socket number within the platform The Master PCU is located in Socket 0-00, as shown. In addition to the links shown, the platforms in a cluster may be connected to a node controller or directly to one another via other types of links, including existing and future wired and optical links. Also, other link configurations may be used, such as node controller NC2 being linked to node controller NC0 directly rather than through node controller NC1, as depicted. As further shown, node controller NC0 is labeled as a Master NC, while node controllers NC1 and NC2 are labeled as Slave NCs.

The coordinated power management operation of the system of FIG. 10 is similar to that discussed above for system 800, except in this instance there are multiple node controllers that operate as slaves (from the perspective of the PCU Master and UBOXes). Accordingly, the message flows for negotiating Pkg C-state entry are similar to that shown in FIGS. 9a and 9b, as discussed above. PMReq.C.Req messages originating from platforms within a cluster associated with a Slave node controller are handled in a manner similar to a Master entity—that is, the Slave node controller receives PMReq.C.Req messages and determines when all platforms within its cluster are requesting EA=0. In response, the Slave node controller generates a consolidated message and sends the message as a single PMReq.C.Req to the Master NC.

The Master NC operates in a similar manner to a Slave controller with respect to handling PMReq.C.Req messages from platforms in its local cluster. Additionally, the Master NC provides further request consolidation functionality with respect to the PMReq.C.Req messages it receives from the Slave NCs. Once the Master NC has received a PMReq.C.Req message with EA=0 from each Slave NC, and all of the platforms in its own cluster have likewise requested EA=0, the Master NC generates a consolidated message that is sent to the Master entity for the system.

Other system topologies may also be implemented using an NC-based approach. For example, the foregoing hierarchical topology can be extended to further levels of system hierarchy. For instance, a system could employ multiple levels of Slave NCs, wherein Slave NCs at levels in the hierarchy between the top and bottom levels serve a dual role as a local Master NC for Slave NCs at a level below the Slave NC, and as Slave NC relative to one or more NCs at a next higher level. In addition, a flat system topology where the sockets behind the NC (from the master cluster's perspective) can communicate directly to the NC attached to the master cluster may be implemented. Moreover, hybrid topologies combining aspects of hierarchical topologies and flat topologies may be implemented based on the techniques disclosed herein.

Response messages (e.g., PMReq.C.Res) and Go messages are communicated in a reverse fashion. For example, rather than consolidating messages, a response or Go message received at an entity at a given level in the node controller hierarchy will be broadcast to all nodes at the next level of the hierarchy, with the message being rebroadcast at each lower level until the messages are received at the platform level. For instance, delivery of a Go message to all platforms in a system including a single Master NC and two Slave NC proceeds as follows. First, a PMReq.C.Go message originating from the Master entity (for the system) is sent to the Master NC. The Master NC then broadcast the Go message to each of the Slave NCs. In turn, the Slave NCs broadcast the Go message to each platform within their cluster.

The techniques disclosed herein provide several advantages over current approaches. The use of the Master-Slave protocol substantially reduces the number of messages that are exchanged between entities to negotiate entry into reduced power states, and inherently avoids race conditions. Extending the Master-Slave concepts to systems employing node controllers provides further advantages, enabling entire systems to be put into a reduced power state in a coordinated manner using a single master entity. Moreover, the concept can be further extended to system architectures employing multiple levels of node controller hierarchy.

The above description of illustrated embodiments of the invention, including what is described in the Abstract, is not intended to be exhaustive or to limit the invention to the precise forms disclosed. While specific embodiments of and examples for, the invention are described herein for illustrative purposes, various equivalent modifications are possible within the scope of the invention, as those skilled in the relevant art will recognize.

These modifications can be made to the invention in light of the above detailed description. The terms used in the following claims should not be construed to limit the invention to the specific embodiments disclosed in the specification and the drawings. Rather, the scope of the invention is to be determined entirely by the following claims, which are to be construed in accordance with established doctrines of claim interpretation.

What is claimed is:

1. A method for effecting power management in a computing platform having a plurality of processors comprising:
employing a master entity in a first processor;
employing a slave entity in each of the plurality of processors;
employing the master entity and the slave entities to effect entry into a reduced power state for each of the plurality of processors to effect a coordinated reduced power state for the computing platform.

2. The method of claim 1, further comprising:
sending power reduction request messages from the slave entities to the master entity, each power reduction request message requesting entry of a processor associated with the slave sending the request message into a reduced power state;
detecting, via the master entity, that each of the slave entities has requested entry into a reduced power;
sending, from the master entity to each slave entity, a command to allow entry of the processor associated with the slave entity into a reduced power state.

3. The method of claim 2, further comprising:
in response to receiving a command to allow entry of a processor a reduced power state,
determining when there is a traffic condition within the processor suitable for entry into a reduced power state; and
in response to the determination of the traffic condition, causing the processor to enter the reduced power state.

4. The method of claim 1, wherein the reduced power state is a deep sleep state, and wherein each of the plurality of processors in the computing platform is caused to enter a deep sleep state.

5. The method of claim 1, further comprising implementing the master entity in a power control unit of the first processor.

6. The method of claim 1, further comprising implementing a slave entity in a power control unit of a processor.

7. The method of claim 1, wherein messages between entities in different processors are sent, in part, over socket-to-socket interconnects.

8. The method of claim 7, wherein the socket-to-socket interconnects comprises QuickPath Interconnect links.

9. The method of claim 1, further comprising:
collecting idle status inputs at a slave entity corresponding to communication activities for the processor associated with the slave entity; and
sending information relating to the idle status inputs to the master entity.

10. The method of claim 9, further comprising:
receiving idle status information from each of the slave entities;
determining a target idle state based on the idle status information;
sending the target idle state to each of the slave entities; and
employing, at the processor associated with each slave entity, the target idle state in entering a reduced power state for the processor.

11. A method for effecting power management in a system including a plurality of computing platforms, each having a plurality of processors, the system including multiple node controllers, each associated with a local cluster including at least one computing platform, the method comprising:
employing a master entity in a first processor of a first computing platform;
employing a slave entity in each of the plurality of processors;
employing the master entity and the slave entities to effect entry into a reduced power state for each of the plurality of computing platform to effect a coordinated global reduced power state for the system.

12. The method of claim 11, further comprising:
collecting, at a master node controller, power reduction requests from multiple platforms in the cluster of the master node controller; and
sending a consolidated power reduction request from the master node controller to the master entity.

13. The method of claim 11, further comprising:
collecting, at a slave node controller, power reduction requests from multiple platforms in the cluster of the slave node controller; and
sending a consolidated power reduction request derived from power reduction requests from the multiple platforms in the cluster from the slave node controller to a master node controller.

14. The method of claim 13, further comprising:
receiving, at the master node controller, consolidated power reduction request from multiple slave node controllers;
consolidating the consolidated power reduction requests received from the multiple slave node controllers into a single request; and
issuing the single request to the master entity.

15. The method of claim 11, further comprising:
sending a message from the master entity to a master node controller;
broadcasting the message from the master node controller to each of a plurality of slave node controllers; and
at each slave node controller, broadcasting the message to each platform in the cluster of that slave node controller.

16. A computing platform, comprising:
a main board having a plurality of sockets;
a plurality of socket-to-socket interconnects;
a plurality of processors, each installed in a respective socket, wherein,
a first processor includes a master entity; and
each processor includes a slave entity,
wherein the master entity and the slave entities are configured to, upon operation of the computing platform, interchange messages to effect coordinated entry of the plurality of processors into reduced power states.

17. The computing platform of claim 16, wherein each processor includes a power control unit (PCU), and wherein the first processor is configured to implement a master entity and slave entity in its PCU, and each of the other processors are configured to implement a slave entity in that processor's PCU.

18. The computing platform of claim 16, wherein the master entity and slave entities comprise Finite State Machines.

19. The computing platform of claim 16, wherein the socket-to-socket interconnects comprise QuickPath Interconnect links.

20. The computing platform of claim 16, wherein the master entity and the slave entities are further configured to perform operations upon operation of the computing platform comprising:
sending power reduction request messages from the slave entities to the master entity, each power reduction request message requesting entry of a processor associated with the slave sending the request message into a reduced power state;
detecting, via the master entity, that each of the slave entities has requested entry into a reduced power;
sending, from the master entity to each slave entity, a command to allow entry of the processor associated with the slave entity into a reduced power state.
